(19) United States
(12) Patent Application Publication
(10) Pub. No.: US 2005/0018938 A1
(43) Pub. Date: Jan. 27, 2005

(54) Sealing structure for the clutch/bearing housing of a roller, such as an output roller

(76) Inventor: Sauli Rajaniemi, Raahe (FI)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/495,395

(22) PCT Filed: Nov. 21, 2002
(86) PCT No.: PCT/FI02/00938

(30) Foreign Application Priority Data
Nov. 21, 2001 (FI) U 20010442

(51) Int. Cl. F16C 33/76

(52) U.S. Cl. 384/489

(57) ABSTRACT

A sealing structure for the clutch/bearing housing of a roller or roll, said housing comprising one or more outward gaps (5c), wherein the housing is provided with a guard ring (13) placed in the gap (5c) in a position parallel to the roller shell and/or with radial sealing parts (12) fitted against the bearings and/or against the wall of the clutch space, said sealing parts being provided with O-rings (14) or equivalent sealing parts of sealing material fitted at their edges, thus preventing grease and firt from getting from the clutch space onto the product itself and/or onto the shell of the roller or roll.

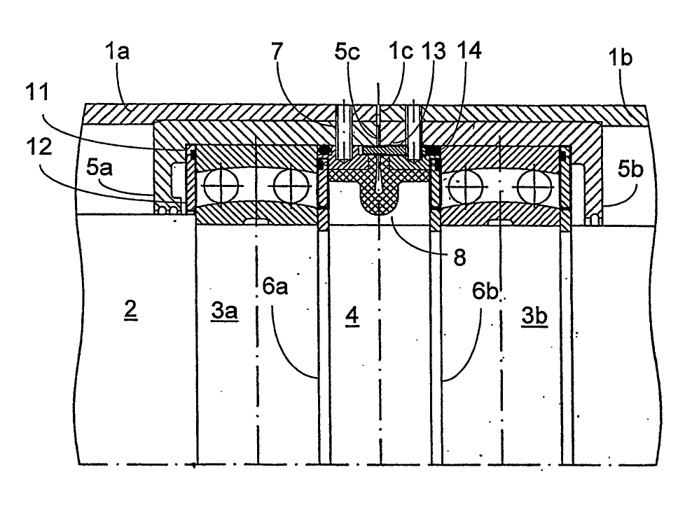

The present invention relates to a sealing structure for the clutch/bearing housing of a roller, e.g. the delivering roller or roll of a paper machine.

The output rollers of paper machines typically consist of several roller shells and a roller core mounted with bearings on the shells. Between the shells, a clutch is provided to transmit rotation to the next shell and to couple the shells together, with rolling contact bearings on either side of the clutch.

A drawback with current clutches is that the clutch housing, which may consist of a common protective casing for both the clutch and the bearings, is unprotected and therefore susceptible to damage caused by dirt, bearing grease etc. For example, when the bearings are being greased, no protection is provided around the bearings; instead, the lubricant, e.g. grease, goes directly into the end ring seal or penetrates into the space inside the roller from the other side of the bearing. Grease causes fast fatigue of the rubber in the end ring seal so that it soon cracks, and it also produces deformations of the rubber, which means that some grease may get directly to the product or to the shell surface. The roller shell and the product itself may thus gather some of the dirt accumulated in the clutch bellows, and this leads to problems and damage in the nip and elsewhere.

Patent specification EP-B1-0 494 437 discloses a sealing structure for the roller bearing of a spreader roll wherein the bearings are protected against grease or oil entering from outside by means of radial discoid sealing plates and O-rings placed against the bearings. The O-ring is fitted inside the circumference of the sealing ring, and the inside of the sealing ring has e.g. a concave curved cross-sectional form. In this way, the flow of oil released from bearing grease is stopped, and no oil will leak out when the roller is stationary.

The solution of the aforesaid specification is not very well suited for the sealing of the clutch/bearing housing because K cannot prevent grease and dirt from leaking from the clutch space onto the product itself or onto the roller shell.

The object of the present invention is to eliminate the drawbacks of prior-art technology and achieve a sealing structure for the clutch/bearing housings of rollers to prevent grease from getting from the clutch space onto the product or onto the roller shell. The fundamental idea of the solution of the invention is that the clutch housing is provided with a guard ring parallel to the roller shell and placed in the gap between the shell parts. In addition, second O-rings are fitted to the ends of the radial sealing plates. By these means, grease and dirt are prevented from getting onto the product itself or onto the roller shell.

The invention affords the advantage that no grease or dirt can get into the production process. In addition, the end ring seal can be protected against grease, and the “pocket” of the end ring seal can be protected with a guard ring to prevent dust produced in the production process from accumulating in the pocket, where it would gradually form larger particles, which could get onto the product and cause damage e.g. to the nip rollers.

In the following, the invention will be described in detail by the aid of an example with reference to the attached drawing, wherein the figure illustrates the sealing of the clutch/bearing housing of an output roller with a sealing structure according to the invention.

The figure represents the shell parts 1a and 1b and the shaft 2 of an output roller. The shell parts 1a and 1b are provided with roller bearings or ball bearings 3a and 3b supporting them on the shaft 2. A clutch 4 is provided between the bearings 3a and 3b. Both the clutch and the bearings are placed in a common protective casing surrounding them. The protective casing comprises two parts 5a, 5b, between which there is a gap 5c corresponding to the gap 1c between the shell parts. The clutch space is additionally provided with end rings 6a, 6b, which are attached to the shell parts via fixing parts 7, with an end ring seal 8 between them.

The bearings are protected by O-rings 11 placed against the bearings and by radial discoid sealing plates 12, inside which the O-rings are fitted. In addition, the clutch space is provided with a guard ring 13 parallel to the roller shell, placed in the gap 5c between the shell parts. Moreover, second O-rings 14 are fitted at the ends of the radial sealing plates. By these means, grease dirt and are prevented from getting from the clutch space onto the product itself or onto the roller shell. Instead of O-rings, it is also possible to use a corresponding seal made of a sealing material, e.g. vulcanized rubber, felt or other material used for sealing.

It is obvious to the person skilled in the art that different embodiments of the invention are not limited to the example described above, but that they may be varied within the scope of the claim presented below.

1. Sealing structure for the clutch/bearing housing of a roller or roll, said housing comprising one or more outward gaps (5c), characterized in that the housing is provided with a guard ring (13) placed in the gap (5c) in a position parallel to the roller shell and/or with radial sealing parts (12) fitted against the bearings and/or against the wall of the clutch space, the said sealing parts being provided with O-rings (14) or equivalent sealing parts of sealing material fitted at their edges, thus preventing grease and dirt from getting from the clutch space onto the product itself and/or onto the shell of the roller or roll.
